(19) United States
(12) Patent Application Publication
(10) Pub. No.: US 2014/0013264 A1
(43) Pub. Date: Jan. 9, 2014

(54) PRODUCTION LINE MODELING SYSTEM AND METHOD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: TA-TUNG LIN, New Taipei (TW); SHU-LIN FENG, Shenzhen (CN)

(21) Appl. No.: 13/928,765

(22) Filed: Jun. 27, 2013

(30) Foreign Application Priority Data
Jul. 3, 2012 (CN) 2012102264857

(51) Int. Cl. G06F 3/0481

(52) U.S. Cl. CPC G06F 3/04817
USPC 715/771

(57) ABSTRACT

A production line modeling method is executed on a computer for designing a production line. The production line includes a plurality of working procedures and a plurality of factors applied to the working procedures, each of which is represented by a first icon and by a second icon respectively. The production line modeling method includes steps of selecting one of the first icons and at least one second icon and combining the selected first icon and second icons to generate a composite third, or target, icon according to a predetermined rule.

### BACKGROUND

1. Technical Field

The present disclosure relates to production lines, particular to a production line modeling system and method for modeling a production line.

2. Description of Related Art

Production line are used in the manufacturing industry because of high production efficiency. Before the production line is put into use, the production line must be modeled. The typical production line modeling method uses icons and characters to model the production line. The icons are used to indicate working procedures of the production line, and the characters are used to explain factors applied to each of the working procedures, for example, such as apparatus, environment, an operating manner needed for the working procedure, and the like. However, the characters are always lengthy and complicated, the production line modeling is unwieldy and not easy to use.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block view of a production line modeling system in accordance with an embodiment.

FIGS. 2-4 are schematic views of graphical user interfaces provided by the production line modeling system in accordance with an embodiment.

FIG. 5 is a flowchart of a production line modeling method in accordance with an embodiment.

### DETAILED DESCRIPTION

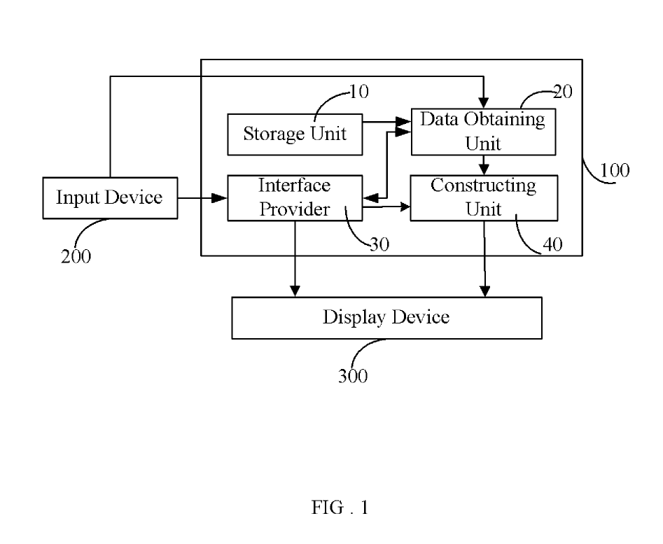

Referring to FIG. 1, a production line modeling system 100 is contained in software, hardware or firmware installed in a computer (not shown) and executed by a processor of the computer. The production line modeling system 100 receives user commands from an input device 200, and generates a production line model and displays the production line model on a display device 300. The input device 200 can be a keyboard, a mouse, or the like. The display device 200 can be an LCD displayer, an LED displayer, or a plasma display panel (PDP) displayer. The production line includes a number of working procedures, and a number of factors applied to the working procedures. In this embodiment, the working procedures include waiting, checking, storing, transferring, feeding, loading, and unloading. Factors applied to the working procedures include operating manners, apparatuses, materials, and states of objects in the working procedure. For example, the operating manner applied to the unloading working procedure is manually operated by manipulator(s), the apparatuses applied to the unloading working procedure are trays, pallets, feed frames, and the states of objects on the unloading working procedure are placed in broken set, and placed in complete set.

The production line modeling system 100 includes a storage unit 10, a data obtaining unit 20, a graphical user interface (GUI) provider 30, and a constructing unit 40.

The storage unit 10 stores a number of first icons, and a number of second icons. Each of the first icons indicates one working procedure. Each of the second icons indicates one factor applied to the working procedures. In the embodiment, each of the first icons corresponds to one or more second icons. Each of the second icons corresponds to one or more first icons.

The data obtaining unit 20 obtains the first icons from the storage unit 10 in response to a command inputted by the user.

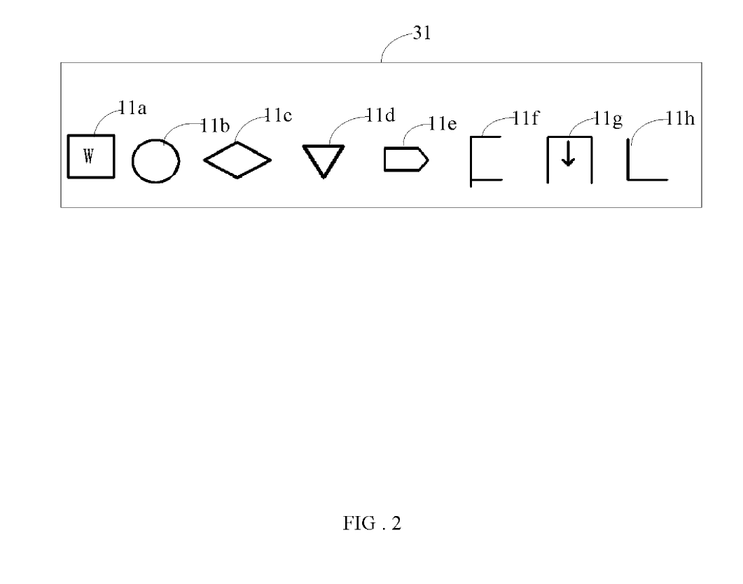

Referring to FIG. 2, the GUI provider 30 provides a first GUI 31 including the first icons, and displays the GUI 31 on the display device 300 to enable user to activate the first icons. The first icons includes a first icon 11a indicating a waiting working procedure, a first icon 11b indicating a processing working procedure, a first icon 11c indicating a checking working procedure, a first icon 11d indicating a storing working procedure, a first icon 11e indicating a transferring working procedure, a first icon 11f indicating a feed providing working procedure, a first icon 11g indicating an unloading working procedure, and a first icon 11h indicating a loading working procedure. The user can click any one of the first icons by the input device 200 to activate the clicked first icon.

The data obtaining unit 20 further obtains the corresponding second icons from the storage unit 10 when any one of the first icons is activated. For example, when the first icon 11g is activated, the data obtaining unit 20 obtains corresponding second icons indicating the factors applied to the unloading working procedure from the storage unit 10.

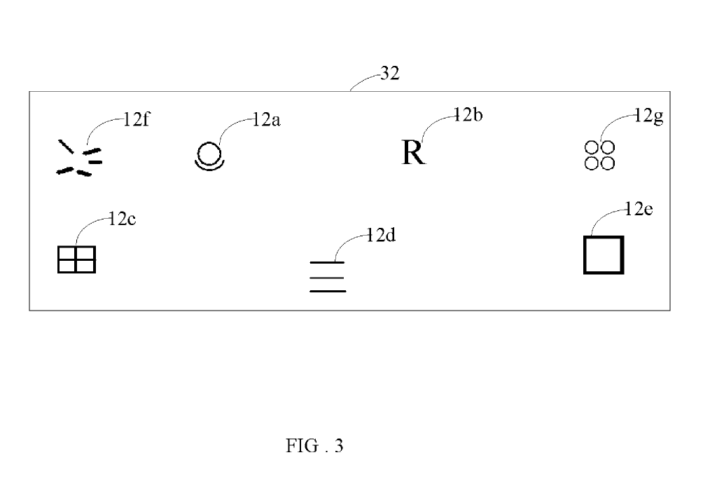

Referring to FIG. 3, the GUI provider 30 provides a second GUI 32 containing the obtained second icons and displays the second GUI 32. The obtained second icons include second icons 12a-12g applied to the working procedure. The second icons 12a-12b indicate that the operating manner is manually operated by a manipulator, typically, the second icon 12a indicates a manual operation, and the second icon 12b indicates the manipulator. The second icons 12c-12e indicate the apparatuses, for example, the second icon 12c indicates that the apparatus is a tray, the second icon 12d indicates that the apparatus is a feed frame, and the second icon 12e indicates that the apparatus is a pallet. The second icons 12f-12g indicate the state of objects on the working procedure, for example, the second icon 12f indicates that the objects are placed in broken set, and the second icon 12g indicates that the object are placed in complete set. The user can click any one of the second icons by the input device 200 to activate the icon. In the embodiment, more than one second icons are activated.

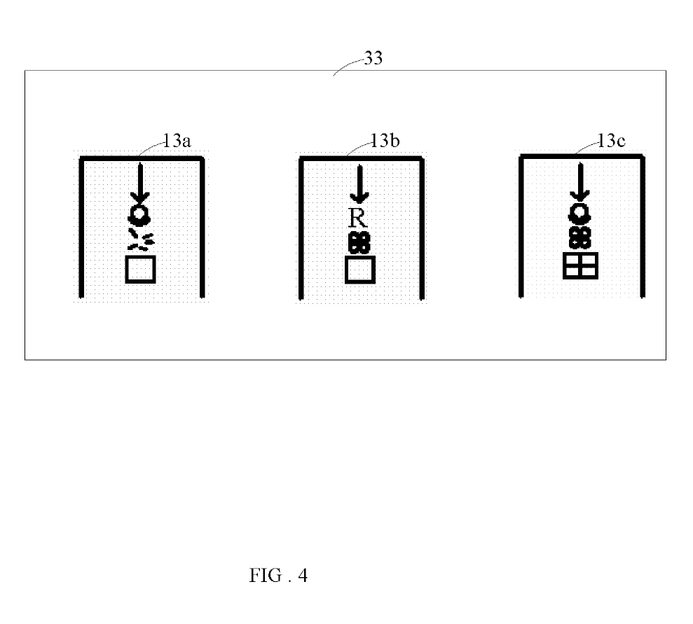

Referring to FIG. 4, the constructing unit 40 combines the activated first icon and second icons to generate a target icon according to a predetermined rule. In the embodiment, the predetermined rule is that the first icon is arranged and then serially followed by the corresponding second icons, and the second icons are arranged in an order of operating mode factor, apparatus factor, materials factor, and state factor one after another. For a first example, if the first icon 11g and the second icons 12a, 12f, and 12e are activated, the constructing unit 40 generates the target icon 13a. For a second example, if the first icon 11g and the second icons 12b, 12g, and 12e are activated, the constructing unit 40 generates the target icon 13b. For a third example, if the first icon 11g and the second icons 12a, 12g, and 12c are activated, the constructing unit 40 generates the target icon 13c.

The GUI provider 30 provides a third GUI 33 containing the target icon and displaying the target icons on the display device 300 in response to an accessing command inputted by the user. Thus, the user can know at a glance the factors applied to each working procedure based on first icon and the second icons contained in the target icon, and the target icon give concise information.

As described above, the first icons and the second icons are displayed on the GUIs 31 and 32 for selection and activation. In another embodiment, the first icons and the second icons may be not displayed and may be selected and activated by pressing corresponding button or keys of the input device 200.

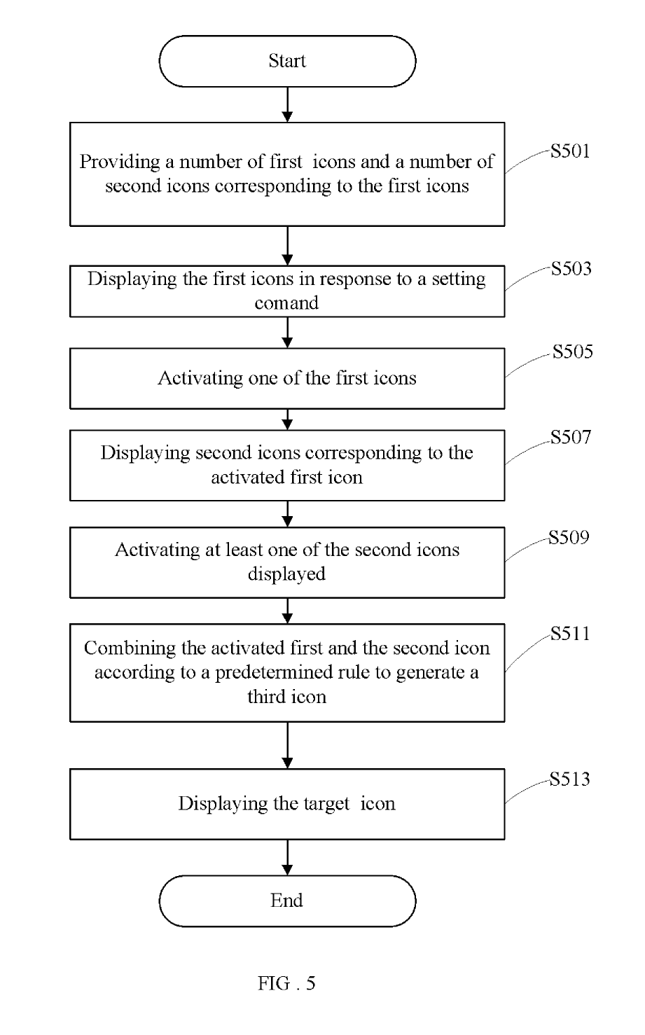

Referring to FIG. 5, the production line modeling method is performed by a processor of the computer (not shown). The production line includes a number of working procedures, and a number of factors applied to the working procedures. The production line modeling method includes the following steps.

In step S501, the storage unit 10 stores a number of first icons, and a number of second icons associated with the first icons. Each of the first icons indicates a working procedure. Each of the second icons indicates a factor to be applied to the working procedures.

In step S503, the GUI provider 30 displays the first icons in response to a command inputted by a user.

In step S505, the GUI provider 30 activates one of the first icons in response to a user' operation. For example, the user can click one of the first icons by the keyboard, a button, or a mouse.

In step S507, the GUI provider 30 displays the second icons corresponding to the activated first icon.

In step S509, the GUI provider 30 activates at least one of the second icons displayed. For example, the user can click one of the at least one second icons by the keyboard, a button, or a mouse.

In step S511, the constructing unit 40 combines the activated first icon and activated second icons to generate a target icon according to the predetermined rule.

In step S513, the GUI provider 30 displays the target icon in response to an accessing command inputted by a user.

As described above, the first icons and the second icons are displayed for selection and activation. In another embodiment, the first icons and the second icons may not be displayed and may be selected and activated by pressing corresponding button or keys of the input device 200.

Even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A production line modeling system, the production line modeling system being executed by a processor of a computer for modeling a production line, the production line comprising a plurality of working procedures and a plurality of factors applied to the working procedures, the production line modeling system comprising:
a storage unit to store a plurality of first icons and a plurality of second icons corresponding to the first icons, each of the first icons indicating one of the working procedures, each of the second icons indicating one of the factors applied to the working procedure;
a data obtaining unit to obtain the first icons from the storage unit in response to a setting command inputted by a user;
a GUI provider to display the first icons on a displaying device; when one of the first icons is activated, the GUI provider further display the second icons corresponding to the activated first icon on the display device to be activated; and
a constructing unit, when the at least one second icon is activated, the constructing unit to combine the activated first icon and the activated second icons to generate a target icon according to a predetermined rule.

2. The production line modeling system of claim 1, wherein the predetermined rule is that the first icon is arranged followed by the corresponding second icon in a serial manner.

3. The production line modeling system of claim 2, wherein the factors applied to the working procedure comprises operating manners, apparatuses, materials, and states of objects on the working procedure; and each of the second icons is to indicate one of the factors respectively.

4. The production line modeling system of claim 1, wherein each of the first icons corresponds to one or more second icons.

5. The production line modeling system of claim 1, wherein each of the second icons corresponds to one or more first icons.

6. A production line modeling method, the production line modeling method being executed by a processor of a computer for modeling a production line, the production line comprising a plurality of working procedures and a plurality of factors applied to the working procedures, the production line modeling method comprising:
providing a plurality of first icons and a plurality of second icons, each of the first icons indicating one working procedure, each of the second icons indicating one of the factors applied to the working procedure;
selecting one of the first icon and at least one second icon; and
combining the selected first and second icons to generate a target icon according to a predetermined rule.

7. The production line modeling method of claim 6, wherein the predetermined rule is that wherein the predetermined rule is that the second icons are arranged in a serial manner, and follows the first icon.

8. The production line modeling method of claim 7, wherein the factors applied to the working procedure comprises operating manners, apparatuses, materials, and states of objects on the working procedure; and each of the second icons is to indicate one of the factors respectively.

9. The production line modeling method of claim 6, wherein each of the first icons corresponds to one or more of the second icons.

10. The production line modeling method of claim 6, wherein each of the second icons corresponds to one or more of the first icons.

11. The production line modeling method of claim 6, wherein before selecting one of the first icon, and the at least one second icon, production line modeling method further comprising:
displaying the first icons;
activating one of the first icons;
displaying the second icons corresponding to the activated first icon; and
activating the at least one second icons.

12. A production line modeling system, the production line modeling system being executed by a processor of a computer for modeling a production line, the production line comprising a plurality of working procedures and a plurality of factors applied to the work procedures, the production line modeling system comprising:
a storage unit to store a plurality of first icons and a plurality of second icons corresponding to the first icons, each icons indicating one of the working procedures, each second icons indicating one of the factors;
a data obtaining unit to obtain one of the first icons from the storage unit, and to obtain at least one of the second icons in response to a setting command inputted by a user; and
a constructing unit to combine the activated first and second icons to generate a target icon according to a predetermined rule.

13. The production line modeling system of claim 12, wherein the predetermined rule is that the second icons are arranged in a serial manner, and follows the first icon

14. The production line modeling system of claim 13, wherein the factors applied to the working procedure comprises operating manners, apparatuses, materials, and states of objects on the working procedure; and each of the second icons is to indicate one of the factors respectively.

15. The production line modeling system of claim 12, wherein each of the first icons corresponds to one or more second icons.

16. The production line modeling system of claim 12, wherein each of the second icons corresponds to one or more first icons.
